(19) United States
(12) Patent Application Publication
(10) Pub. No.: US 2021/0089297 A1
(43) Pub. Date: Mar. 25, 2021

(54) AUTOMATED CHECK FOR TICKET STATUS OF MERGED CODE

(71) Applicant: Sungard Availability Services, LP, Wayne, PA (US)

(72) Inventor: James Duvall, Wayne, PA (US)

(21) Appl. No.: 16/577,479

(22) Filed: Sep. 20, 2019

(51) Int. Cl. G06F 8/71; G06F 8/30; G06F 9/54; H04L 29/08

(52) U.S. Cl. CPC G06F 8/71; G06F 8/30; H04L 67/02; G06F 9/541; G06F 9/546

(57) ABSTRACT

An automated approach that prevents uncompleted work, such as software code still under development, from being automatically merged onto a target branch (or code master). Open engineering tickets are completed before a development branch is permitted to be automatically merged into the target branch. The approach adds an additional step during a typical automated build process. The additional step determines the latest commit to the target, and then reviews the commits from the latest commit in the target to the most recent merge commit of the source branch, and captures the ticket IDs. Using those ticket IDs, a ticketing system is accessed to determine the status of each ticket and its associated subtasks. If any of the statuses are not closed, a failure is reported, preventing the branch from being merged into the target.

### BACKGROUND

Configuration management (also called version control) is a critical part of ensuring that a product conform to expectations, and that any changes to existing versions are properly evaluated, authorized, and implemented. One common approach in software development is the controlled duplication of an object (such as a source code file). In this way modifications can happen in parallel in a development environment, along different “branches”, without affecting a released “production” (or parent) version.

Complex products often result in many different development projects, each having one or more roles such as new feature development, bug fixing, build management, version integration, quality assurance, and others. Further, multiple releases for different operating system platforms may have to be maintained. Branches allow these different contributors to isolate their changes in different branches, and test these branches without destabilizing the code base.

For example, a “development branch” may be a version that is undergoing the addition of new features and which has not yet been officially released to customers. The development branch may originate as “pull request” to generate a copy or “clone” of a released version in a code repository. Once a pull request is open, potential changes can be reviewed among collaborators. After the developers are happy with proposed changes, they can then “merge” the pull request with the code master.

Pull requests thus provide support for peer code reviews and merges as part of a branch-based development workflow, helping to protect the production code. But as a development effort becomes more complex, more flexibility is needed. Some systems thus support a “merge check” feature that helps ensure changes implemented by pull requests are fully vetted before they are merged.

Certain products such as Atlassian BitBucket Server, disable merge checks by default. However, these can then later be enabled or disabled at the project level, for all repositories in a project, or for individual repositories. Example merge checks within BitBucket Server include “all reviewers have approved”, or “minimum number of approvals”, or “no incomplete tasks”.

### SUMMARY

This patent application describes an automated approach that prevents uncompleted work, such as software code still under development, from being automatically merged onto a target branch (or code master). The approach ensures that, for example, any open engineering tickets are completed before a development branch is permitted to be automatically merged into the target.

The approach adds an additional step during a typical build process. The additional step determines the latest commit to the target, and then reviews the commits from the latest commit in the target to the most recent merge commit of the source branch, and captures the ticket IDs. Using those ticket IDs, it then accesses a ticketing system to determine the status of each ticket and its associated subtasks. If any of the statuses are not closed, a failure is reported, preventing the branch from being merged into the target.

In one embodiment, the ticket IDs are determined using a certain naming convention, such as by including the ticked IDs in each Branch Name, each Commit Message and each Merge Message associated with the branch. This permits the system to automatically collect a list of affected Merge messages, given that Branch Names contain the ticket ID, and that both the Commit Messages and Merge Messages also contain the associated Branch Names. The ticketing system can then be automatically queries using each affected ticked ID to determine their status.

### BRIEF DESCRIPTION OF THE DRAWINGS

FIG. 1 shows an example development environment where an automated check for ticket status process may be implemented.

FIG. 2 is an example of such a process.

FIG. 3 also illustrates an example process executed by a build agent, similar to FIG. 2 but in flow chart form.

FIG. 4 illustrates an example of the source code repository naming conventions that can enable automatic ticket status validation.

FIG. 5 illustrates an example ticket ID “CB-6561”.

FIG. 6 is an example work flow.

FIG. 7 shows how the work flow of FIG. 6 improves with ticket status check step added.

### DETAILED DESCRIPTION OF A PREFERRED EMBODIMENT

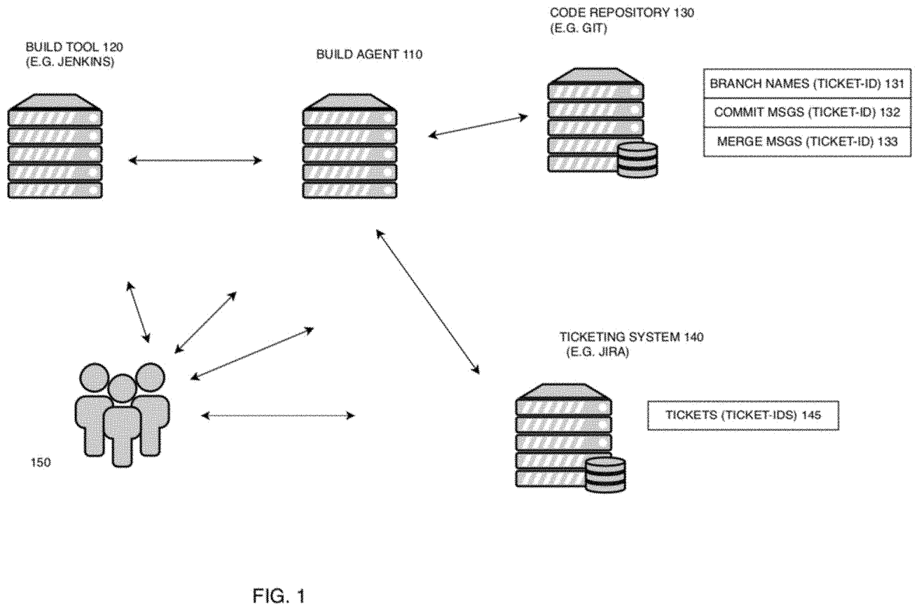

FIG. 1 shows an example development environment 100 where an automated check for ticket status process may be implemented. The environment 100 consists of a build agent 110, a build tool 120, a code repository 130, and a ticketing system 140. Developers 150 interact with the build agent, build tool 120, repository 130 and ticketing system 140 in various ways, manually, and of importance here, via an automated process.

In one example implementation the build tool 120 is an automation application adapted for continuous integration, testing, and building of code projects. One example build tool is the open source automation server known as Jenkins (http://jenkins.io)

The build agent 110 is typically a container or client of the build tool 120.

The code repository 130 can be a database adapted for distributed version control, such as the open source Git (httpw://git-scm.com/)

The ticketing system 140 is an issue and project status tracking tool, such as Jira™ available from Atlassian. “Tickets” may be generated, for example, for each feature being added, or bug being fixed, or test being run, etc. Ticketing system also typically supports the concept of task sets, such that resolving a ticket may involve performing one or more tasks each consisting of a number of sub-tasks.

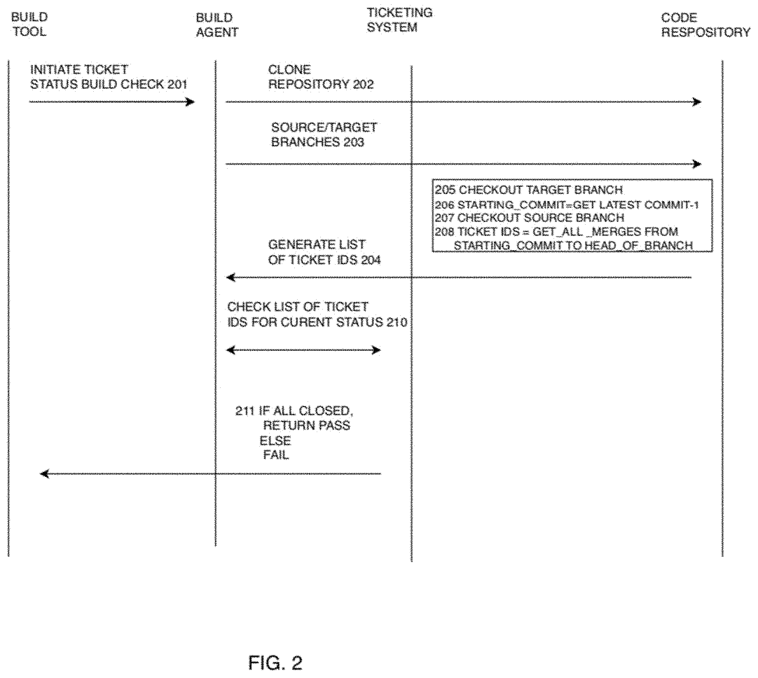

The build agent 110 executes a script that interacts with these different components 120, 130, 140 to perform the functions described herein. One example process is shown in FIG. 2.

In step 201, the build tool initiates an automated build check request to the build agent 110. The request may come from an input by a user 150 or may be triggered by an event.

In a next step 202 the build agent then requests the code repository 130 to create a clone of the source branch for the new build.

Next, in step 203, the build agent 110 queries the code repository 130 (e.g., the clone) to obtain a list of affected source branches and target branches. The build agent 110 (either on its own, or by cooperating with the code repository 130) generates a list of affected ticket IDs.

This list of affected ticket IDs can be generated 204 via a number of steps. For example, a step checks out the target branch 205 from the repository 130. Step 206 then determines that a starting commit for the target branch should, for example, be the commit prior to the latest commit to the branch. In one implementation, the fact that Git keeps track of the commits to the repository, enables the build agent 110 to checkout a particular branch and reviewing the commits to that branch.

Next, the source branch is then checked out step 207. The list of affected ticket IDs is then determined at step 208. The list will include all merges from the starting commit to the ending commit to the head of the branch. This list of ticket IDs is then returned to the build agent 110 at step 209.

At step 210 the build agent 110 then takes the list of ticket IDs, and checks the current status of each one by making a query to the ticketing system 140. If all tickets and associated tasks are closed, then the automated check is passed, and the build can commence 211. Otherwise, if any tickets are still open, the build will not proceed.

Referring back to FIG. 1, step 208 can be automated due to the fact that the code repository 130 observes a particular naming convention for branch names 131, commit messages 132 and merge messages 133, and utilizing the fact that the ticketing system 140 generates a unique ticket IDs for each ticket 145.

One preferred naming convention is to have a branch name 131 always include the associated ticket ID. Commit messages associated with the branch follow the same naming standard—that is, they also include the ticket ID. Merge messages similarly contain the associated ticket ID.

It is possible to potentially use a different naming conventions. However, the Ticket ID should typically be present somewhere in the Branch Name or otherwise be algorithmically related in some way to the commit message, or some other approach that makes it possible to correlate them to one another.

It is preferred to generally have only one ticket per branch, but it may be possible to support situations where the developer may fix a bug in the same branch that the bug was against. In other words, while a software developer was in the process of developing a new “Feature-1”, Quality Assurance (QA) may have found a bug therein, and the engineer may have fixed it in the “Feature 1” Branch. In that instance the commit message should have the Ticket ID of the bug ticket.

A merge to the master(production) branch starts by determining the last time a merge was performed onto master and using that as the starting point. The ending point is the head of the source branch that will be merged into master. All associated tasks (merges to the source branch) are then checked for completion, with the understanding that some tasks may include some manual steps like documentation tasks, and non-automated testing

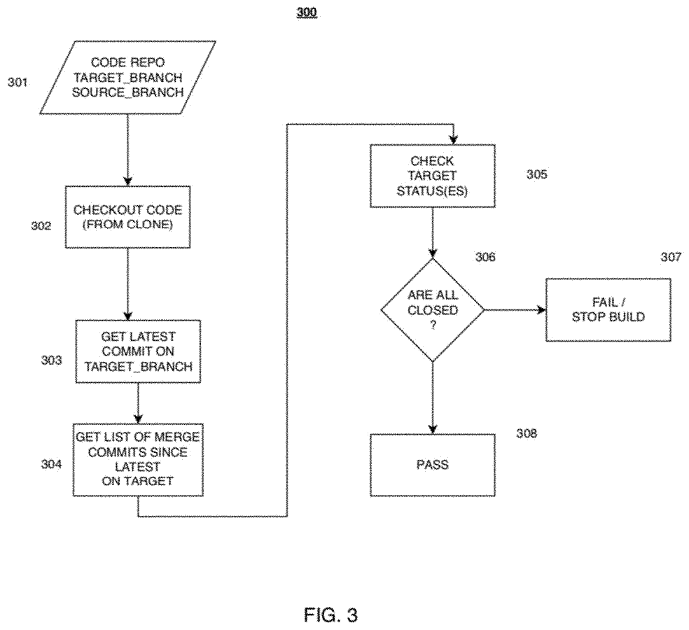

FIG. 3 also illustrates an example process 300 executed by the build agent 110, similar to FIG. 2 but in flow chart form. At some point 301, the target branch and source branch have been stored in the code repository 130. Step 302, typically initiated by a code build request, then creates a clone of the target and source. At 303, the most recent commit on the target branch is determined. At 304 a list of merge commits that have occurred since the latest merge on the target branch is then obtained. The status(es) of these merges are then fetched in state 305 and checked in state 306. If they are all closed, then the build can proceed in step 308. If any tickets are still open, then the build is stopped at step 307.

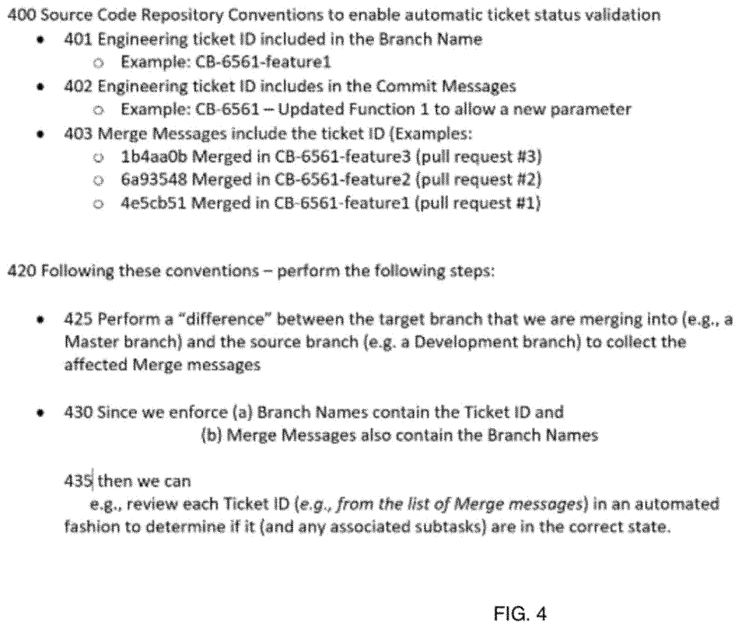

FIG. 4 illustrates one example of the source code repository naming conventions that can enable automatic ticket status validation.

As mentioned above, a first convention 401 is to have the engineering ticket ID included in the branch name. In this example, the text of the name of the branch, as stored in the code repository 130, is “CB-6561-feature one”, indicating that this branch has an associated ticket ID “CB-6561”. Note the ticket ID, originally generated by the ticketing system 140, was then added to the name of the branch as stored in the code repository 130. The name of the branch can be manually assigned by the developer 150 at the time the ticket and the branch are initially created in the respective systems 140, 130.

(Jira Provides an automated way to create the branch name via the ticketing system—however it is also possible for the developer(s) to manually create the branch with the desired naming convention. In another approach, the naming convention may be enforced by the build agent.

Another convention observed 402 is to include the engineering ticket ID in any commit messages. In this example, a commit message has been labeled “CB-6561—Updated function 1 to allow a new parameter”. This label can be assigned manually by a developer 150 working on the branch.

The third convention is to have the ticket ID included in the names of any merge messages associated with branch. Here there are three such merge messages, each associated with a different pull request, but each having the same ticket ID “CB-6561” within its respective merge message name.

Given these naming conventions, the list of ticket IDs affected by the merge can be generated as follows. In step 425, the process can automatically determine a difference in the merge messages associated with the target branch (such as a master branch) and the merge messages in the source branch (such as a development branch). The difference provides a list of affected merge messages.

At state 430, since it is known that merge messages also contain the branch names, the automated process can run through the list of merge messages, and extract the ticket IDs from their names. The ticket IDs can then be queried to the ticketing system 140 to determine if any associated subtasks are in the correct state.

That is, in other words, starting with the affected branch name, the automated process can determine a list of commit messages and the merge messages associated with those commits. From that list of names for the affected merge messages, the process can determine the IDs for all affected tickets.

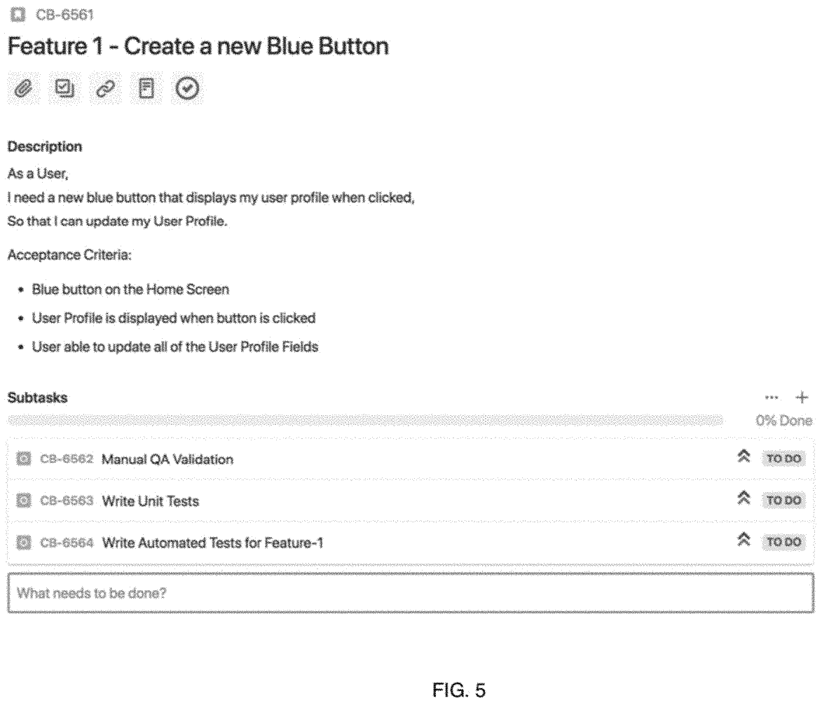

FIG. 5 illustrates what the example ticket ID CB-6561 represents. In this example, the developer 150 is creating a development branch that adds a new feature, called “Feature-1”, which is a blue button in a user interface. When clicked, the blue button should display a user's profile, and should enable the user to update their profile.

A list of acceptance criteria for the ticket includes
Being able to see the blue button on the home screen
Ensuring that the user profile is displayed when the button is clicked and
Confirming that the user is able to update all of the user profile fields.

Three subtasks must also be successfully completed before the development branch will be allowed to be merged with the target. These include
CB-6562 manual QA validation (subtask CB-6562)
CB-6563 write unit tests
CB-6564 write automated test for Feature-1

The ticket specifies that these acceptance criteria must each pass before the development branch for this feature can be allowed to be merged onto the into the target (production) branch.

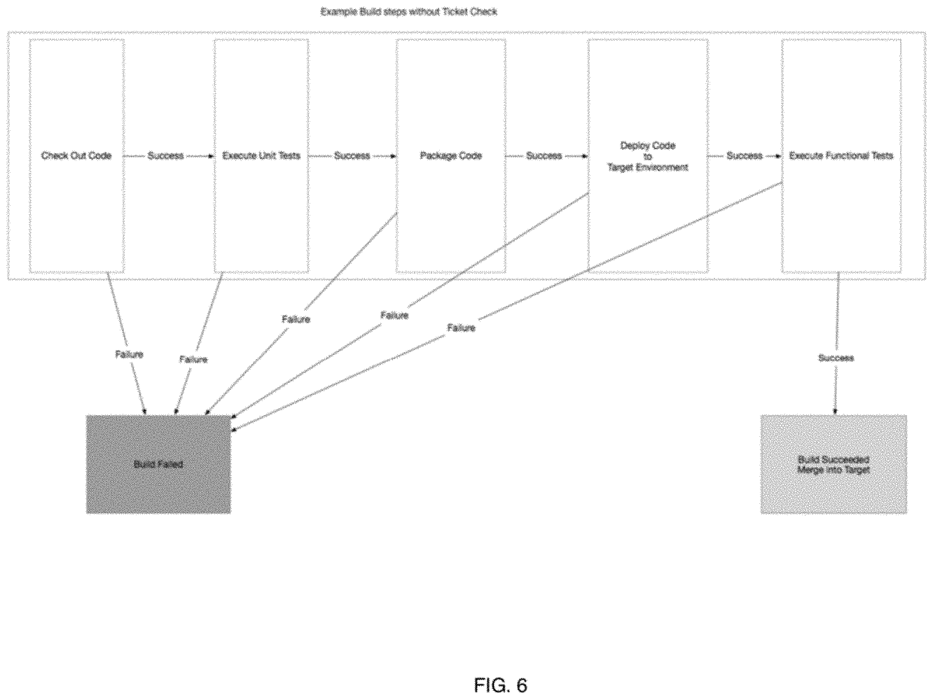

FIG. 6 is an example work flow 600 that might occur in the prior art without the automated test check process described herein. For example the user might check out code 610, then execute a unit test 612, package the code 614, deploy code 616 to a target environment, and then execute functional testing 618. A failure at any of step 610, 612, 614 or 616 causes the build to fail to state 605.

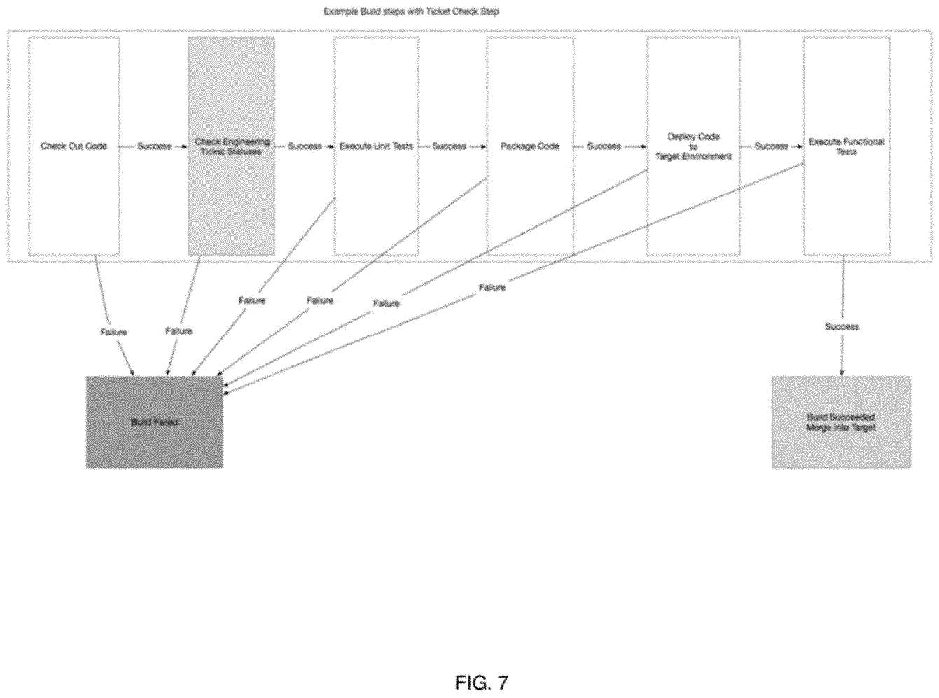

FIG. 7 shows how this work flow improves with ticket status check step added. As in the previous approach, code is checked out 710, a unit test is executed 712, code is packaged 714, deployed to the target environment 716, and functional tests are executed 718. However an additional step 715 has been added between checking out code 710 and executing unit tests 712.

This automated check 715 permits the workflow to determine that a build or test would fail, prior to executing any of unit test 712, packaging code 714, deploying code 716 or executing functional tests 718. By adding this new step, the developers can prevent a unsuccessful build merge from even being attempted when any tickets statuses are not marked as complete.

In other words, with the prior art example of FIG. 6 the build process is not automatically cognizant of the engineering ticket status and thus allow merges of code that could potentially still have unfinished associated work yet to be completed. Thus by adding the new step 715, any erroneous code deliveries can be prevented.

Implementation Options

The foregoing description of example embodiments provides illustration and description of systems and methods for implementing Recovery as a Service, but is not intended to be exhaustive or to limited to the precise form disclosed.

While specific embodiments have been discussed, it will now be apparent that other variations and modifications may be made to the described embodiments, with the attainment of some or all of their advantages. Therefore, it is the object of the appended claims to cover all such variations and modifications as come within the true spirit and scope of the disclosure and their equivalents.

For example, the embodiments described above may be implemented in many different ways. In some instances, the various “data processing systems” described herein may each be implemented by a separate or shared physical or virtual general purpose computer having a central processor, memory, disk or other mass storage, communication interface(s), input/output (I/O) device(s), and other peripherals. The general purpose computer is transformed into the processors with improved functionality, and executes the processes described above to provide improved operations. The processors may operate, for example, by loading software instructions, and then executing the instructions to carry out the functions described.

As is known in the art, such a computer may contain a system bus, where a bus is a set of hardware lines used for data transfer among the components of a computer or processing system. The bus or busses are shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof. In some implementations, the computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing. By aggregating demand from multiple users in central locations, cloud computing environments can be built in data centers that use the best and newest technology, located in the sustainable and/or centralized locations and designed to achieve the greatest per-unit efficiency possible.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. It further should be understood that certain implementations may dictate the block and network diagrams and the number of block and network diagrams illustrating the execution of the embodiments be implemented in a particular way.

Other modifications and variations are possible in light of the above teachings. For example, while a series of steps has been described above with respect to the flow diagrams, the order of the steps may be modified in other implementations. In addition, the steps, operations, and steps may be performed by additional or other modules or entities, which may be combined or separated to form other modules or entities. For example, while a series of steps has been described with regard to certain figures, the order of the steps may be modified in other implementations consistent with the principles of the invention. Further, non-dependent steps may be performed in parallel. Further, disclosed implementations may not be limited to any specific combination of hardware.

Certain portions may be implemented as “logic” that performs one or more functions. This logic may include hardware, such as hardwired logic, an application-specific integrated circuit, a field programmable gate array, a microprocessor, software, wetware, or a combination of hardware and software. Some or all of the logic may be stored in one or more tangible non-transitory computer-readable storage media and may include computer-executable instructions that may be executed by a computer or data processing system. The computer-executable instructions may include instructions that implement one or more embodiments described herein. The tangible non-transitory computer-readable storage media may be volatile or non-volatile and may include, for example, flash memories, dynamic memories, removable disks, and non-removable disks.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Also, the term “user”, as used herein, is intended to be broadly interpreted to include, for example, a computer or data processing system or a human user of a computer or data processing system, unless otherwise stated.

What is claimed is:

1. A system comprising:
a code repository, for storing a code project including one or more source code files, and performing related functions including source code branch, commit and merge to master management;
an automated build tool, for automated compilation of source code files and generating a target code branch;
a ticketing system, for maintaining and managing a list including ticket IDs of open tasks related to the code project; and
an agent, for preventing uncompleted source code files from being automatically merged into the target code branch, the agent further for:
checking out, from the code repository, a code branch;
automatic validation of ticket status by
requesting, from the ticketing system, the list of ticket IDs related to the code branch; and
if all ticket IDs in the list have a closed status, then
enabling the automated build tool to compile the target code branch; else
preventing the automated build tool from compiling the target code branch.

2. The system of claim 1 automatic ticket status validation is enabled by:
Including a ticket ID in each Branch Name;
Including a ticket ID in each Commit Message;
Including a ticket IDs in each Merge Message;
and the agent is further for:
performing a difference comparison between the target branch that is being merged into (or a Master branch) and the source branch (or a development branch), to collect the Merge messages;
given that Branch Names contain the Ticket ID, and Merge Messages contain the Branch Names, further
reviewing each ticket to determine any associated subtasks are in a closed state.

3. The system of claim 1 wherein one or more of a branch name, commit indicator or merge indicator associated with each source code file in a source code project includes a ticket ID.

4. The system of claim 2 wherein
the step of checking out the code branch further comprises determining a latest commit on a target branch; and
the step of requesting a list of ticket IDs is limited to merge commits since the latest commit.

5. The system of claim 1 wherein the code repository maintains a list of code merge indicators ranging from a starting commit version to a head of code branch version.

6. The system of claim 1 wherein some of the ticket IDs relate to tasks that are automated tasks, and others are manual tasks.

7. The system of claim 1 wherein the ticketing system is a Jira instance.

8. The system of claim 1 wherein the build tool is a Jenkins instance.
